(19) United States
(12) Patent Application Publication
(10) Pub. No.: US 2020/0295376 A1
(43) Pub. Date: Sep. 17, 2020

(54) CARBON SPHERES FOR STABLE, HIGH ENERGY BATTERY ELECTRODES

(71) Applicant: Sparkle Power LLC, Rochester, NY (US)

(72) Inventors: David Mitlin, Lakeway, TX (US); Jia Ding, Tianjin (CN)

(21) Appl. No.: 16/815,135

(22) Filed: Mar. 11, 2020

Related U.S. Application Data
(60) Provisional application No. 62/816,387, filed on Mar. 11, 2019.

(51) Int. Cl. H01M 4/66; H01M 4/04; H01M 4/60; H01M 2/16; H01M 10/0525

(52) U.S. Cl. CPC H01M 4/663; H01M 4/0471; H01M 2004/027; H01M 2/1673; H01M 10/0525; H01M 4/602

(57) ABSTRACT

A battery electrode including a plurality of carbon-based spheres, wherein at least one of said carbon-based spheres includes a shell and a hollow interior, the shell formed from a carbon precursor grafted with heteroatom moieties. A battery that includes a cathode and an anode, wherein either the cathode or the anode includes a plurality of carbon-based spheres, wherein at least one of said carbon-based spheres includes a shell and a hollow interior, the shell formed from a carbon precursor grafted with heteroatom moieties. A process for producing a carbon-based sphere.

### CROSS-REFERENCE TO RELATED APPLICATIONS

The instant application claims priority to co-pending U.S. Provisional Application No. 62/816,387, filed on Mar. 11, 2019, and entitled “Sulfur Chemically Grafted Inside Ion Active Carbon Spheres for Stable—High Energy Battery Electrodes”. The entirety of the aforementioned provisional application is incorporated by reference in its entirety.

### FIELD OF THE INVENTION

The present invention relates to batteries, and more particularly to carbonaceous material for electrodes used in alkali ion batteries, specifically carbon spheres used in battery electrodes.

### BACKGROUND OF THE INVENTION

Lithium ion batteries (LIBs) are a successful energy storage system. Unfortunately due to the limited global lithium resources, the scaling up of demand has exerted severe stress on the cost control of LIB products. In view of the limited lithium resources more abundant alkali elements to replace lithium are being pursued, which promotes the exploration of sodium ion batteries (NIBs) and potassium ion batteries (KIBs).

Carbon material (also referred to as “carbonaceous material”) is an important category of anode for alkali ion batteries. The most classic carbon anodes include graphite in LIBs, KIBs, and hard carbon in NIBs. These carbon materials as anodes exhibit practical performance in terms of specific capacity, working voltage and reaction kinetics, which fulfill the requirement of full cells at the present stage. However, under the circumstance of pursuing higher energy density and faster charging ability of batteries, exploration in carbon anodes is not limited to these basic candidates. Because of the highly controllable physicochemical properties of carbon materials, there is substantial progress in developing advanced carbon anodes with significantly improved electrochemistry. Most of the improvement resulted from the synergetic effect of tuning various physicochemical characteristics in carbon materials, including morphology, graphitic tissue, porous structure, surface chemistry, and the like.

Heteroatom (N, B, S, Se, P, etc.) modification of carbon material is an effective method to increase the specific capacity of the carbon anode. Besides the intrinsic intercalation capacity, heteroatom modification is able to provide extra capacitive capacity through the enhanced non-faradic surface ion absorption as well as the faradic reaction between surficial heteroatoms and ions (i.e. pseudocapacitance). For lithium carbon anodes, many heteroatom containing carbon anodes delivered over 1200 mAhg⁻¹ capacity, which is three times higher than graphite. However, in the sodium and potassium systems, the capacity improvement by heteroatom modification is not as pronounced as in the lithium system. The top-performing heteroatom modified carbon anodes exhibit mainly around 500 mAhg⁻¹ capacity in a sodium half-cell, which is maximum 1.7 times of hard carbon (300 mAhg⁻¹). In KIBs, the effect of heteroatoms is even less pronounced and exhibit specific capacity of approximately 350 mAhg⁻¹, which is approximately 30% higher than graphite (273 mAhg⁻¹). In order to magnify the effect of surficial functionality, the carbon needs to be nano-sized or porous-made to increase the active surface area. Those procedures can diminish the graphitic order of the carbon, thus inevitably elevating the working voltage and increasing potential hysteresis. From an energy density point of view, the limited improvement in capacity for the heteroatom modified carbons cannot compensate for the voltage increase-induced energy density sacrifice and larger hysteresis-induced energy efficiency sacrifice.

The extra capacity related to the heteroatoms is mostly capacitive in nature, indicating that the electrochemical activity is mainly limited in the surficial heteroatoms. Given the total heteroatom content of <15 wt % for most of the reported carbons, the content of truly active surficial heteroatom is even lower. Thus, the heteroatom is so significantly diluted in the carbon matrix that negligible elemental-grade (e.g. O₂, S₈) activity can be delivered, instead only the single atomic species are functional in electrochemistry. In sum, the overall low level heteroatom doping and the reaction limitation in the surficial areas are the main reasons of the limited capacity improvement by heteroatom modification strategy.

Therefore, it is desired to further increase the capacities of heteroatom modified carbon materials. It is further desired to at least double the capacities of the classical graphite and hard carbon anodes in the sodium and potassium systems.

### SUMMARY

In one embodiment, the present invention is directed to a sulfur grafted hollow carbon spheres (SHCS) as Li, Na and K electrodes, employable as either the anode or the cathode.

In another embodiment, the present invention is directed to SHCS with a content of sulfur (37.61 wt. %) uniformly distributed in the bulk carbon framework (i.e. 40 nm thick carbon sphere shells) through atomic-level chemical bonds. Based on the kinetics analysis, the sulfur mainly underwent a diffusion controlled redox reaction, indicating the electrochemical activity of sulfur within the carbon bulk. Based on the combination of the intercalation reaction of alkali ions in the carbon phase and redox reaction of alkali ions with sulfur, the SHCS can totally deliver 805 mAhg⁻¹ and 581 mAhg⁻¹ capacity in Na and K cells respectively, being 2.6 and 2.1 times of the capacities of the hard carbon in NIBS and graphite in KIBs.

Another embodiment of the invention is directed to a battery electrode comprising: a plurality of carbon-based spheres, wherein at least one of said carbon-based spheres comprises a shell and a hollow interior, the shell formed from a carbon precursor grafted with heteroatom moieties. In one embodiment, the carbon precursor is selected from the group consisting of styrene-based polymers, formaldehyde polymers, cellulosic polymers, epoxy resins, polyacrylonitrile, and combinations thereof. In a particular embodiment, the carbon precursor is a formaldehyde polymer, specifically resorcinol formaldehyde.

In one embodiment the heteroatom moieties are selected from the group consisting of N, B, Se, S, P, and combinations thereof. In particular, the heteroatom moieties are S. In a particular embodiment, the shell comprises at least 5 wt. % S based on the total weight of the shell.

In one embodiment, the heteroatom moieties are uniformly distributed throughout a framework of the shell.

A further embodiment of the invention is directed to a battery comprising: an anode; a cathode; a separator disposed between the anode and the cathode; and an electrolyte in physical contact with both the anode and the cathode, wherein one of the anode and the cathode is the battery electrode according to any of the foregoing embodiments.

In one embodiment, the battery is a, lithium ion battery, a potassium ion battery or a sodium ion battery.

A further embodiment is directed to a process for producing a heteroatom grafted carbon sphere, the process comprising: (a) providing a carbon precursor and a plurality of silica spheres; (b) forming, by a hydrothermal method, carbon precursor spheres comprising a carbon precursor shell and a silica core; (c) providing a heteroatom source and combining the heteroatom source with the carbon precursor spheres; (d) heating the combined heteroatom source and carbon precursor spheres such that the carbon precursor shell carbonizes to form a shell having a graphitic framework with heteroatom moieties uniformly grafted throughout the graphitic framework, thereby forming a heteroatom grafted carbon sphere comprising a silica core; and (e) contacting the heteroatom grafted carbon sphere with an acid to remove the silica core, thereby forming a heteroatom grafted carbon sphere.

In one embodiment of the process, the carbon precursor is selected from the group consisting of styrene-based polymers, formaldehyde polymers, cellulosic polymers, epoxy resins, polyacrylonitrile, and combinations thereof. In a specific embodiment, the carbon precursor is a formaldehyde polymer, particularly resorcinol formaldehyde.

In one embodiment of the process, the heteroatom source includes heteroatom moieties selected from the group consisting of N, B, S, Se, P, and combinations thereof. In particular, the heteroatom moieties are S.

In one embodiment of the process, the shell of the heteroatom grafted carbon sphere comprises at least 5 wt. % heteroatom based on the total weight of the shell.

In one embodiment of the process, the heating step is conducted for between about 1 to 24 hours at a temperature of between about 100-1500° C.

The foregoing embodiments, as well as other embodiments and aspects, are discussed in more detail herein. It is contemplated that two or more of the various embodiments described herein can be combined.

### BRIEF DESCRIPTION OF THE DRAWINGS

FIG. 1 is a schematic illustration of a carbon-based sphere according to an embodiment disclosed herein.

FIG. 2 is a front view of an energy storage device according to an embodiment disclosed herein.

FIG. 3 is a process flow diagram of a process according to an embodiment disclosed herein.

FIG. 4 is a schematic of a process according to an embodiment disclosed herein.

FIGS. 5(a)-(f) are SEM (scanning electron microscope) and TEM (transmission electron microscope) images of spheres according to embodiments herein. FIG. 5(g) is a HAADF (high angle annular dark field) image of spheres according to embodiments herein.

FIG. 6(a) is a graph illustrating TGA curves of SHCS and RFC baseline; 6(b) is a graph of XRD patterns of SHCS sample and commercial sulfur powder; 6(c) is Raman spectra of SHCS sample and commercial sulfur powder; 6(d) is XPS survey spectra; 6(e) is high resolution XPS S2p spectrum of SHCS.

### DETAILED DESCRIPTION OF THE INVENTION

In one aspect, the present invention a battery electrode that includes a plurality of carbon-based spheres. In one embodiment, the battery is an alkali ion battery, in particular, a lithium ion battery, a sodium ion battery, or a potassium ion battery. The electrode is one of a cathode or an anode.

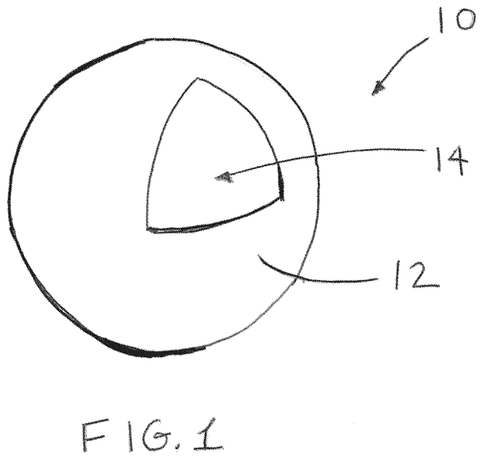

As shown in FIG. 1 a carbon-based sphere 10 includes a shell 12 and a hollow interior 14. The shell 12 is formed from a carbon precursor grafted with heteroatom moieties. The term “grafted” means that the heteroatom moieties are inserted in the carbon precursor. In one embodiment, the carbon precursor is selected from styrene-based polymers, formaldehyde polymers, cellulosic polymers, epoxy resins, polyacrylonitrile, and combinations thereof. In a particular embodiment, the carbon precursor is a formaldehyde polymer. In a particular embodiment, the carbon precursor is resorcinol formaldehyde.

The term “sphere” as used herein means a generally round figure with every point on its surface generally equidistant from its center, however the spheres 10 are not so limited to “perfect” spheres and therefore also include sphere-like, sphere-similar figures, sphere-suggestive figures, dense particles that somewhat resemble a sphere, and/or dense particles, all of which, with the exception of the geometric shape of the figure, otherwise fit the aforementioned description of the sphere 10 shown in FIG. 1, i.e., have a shell 12 and a hollow interior 14, with the shell forme carbon precursor grafted with heteroatom moieties.

In one embodiment the heteroatom moieties are nitrogen (N), boron (B), selenium (Se), sulfur (S), phosphorus (P), and combinations thereof. In particular, the heteroatom moieties are S, however the invention is not limited in this regard as any combination of heteroatom moieties can be grafted in the carbon precursor and present in the shell 12. In a particular embodiment, the shell 12 includes at least 5 wt. % heteroatom moieties based on the total weight of the shell, more particularly at least 10 wt. % heteroatom moieties based on the total weight of the shell, more particularly at least 15 wt. % heteroatom moieties based on the total weight of the shell, more particularly at least 20 wt. % heteroatom moieties based on the total weight of the shell, more particularly at least 25 wt. % heteroatom moieties based on the total weight of the shell, more particularly at least 30 wt. % heteroatom moieties based on the total weight of the shell, more particularly at least 35 wt. % heteroatom moieties based on the total weight of the shell. In a specific embodiment, the shell 12 includes at least 35 wt. % S based on the total weight of the shell.

In one embodiment, the heteroatom moieties are uniformly distributed throughout a framework of the shell 12.

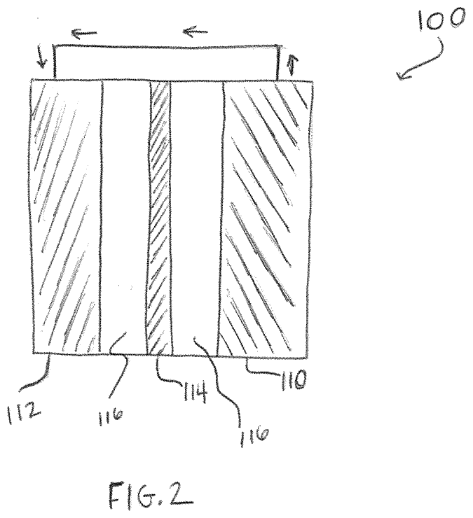

As shown in FIG. 2, a further embodiment of the invention is directed to an energy storage device, e.g., a battery, 100 that includes at least one electrode. As shown in FIG. 2, the battery 100 includes an anode 110 and a cathode 112. The battery 100 also includes a separator 114 disposed between the anode 110 and the cathode 112 and an electrolyte 116 in physical contact with both the anode 110 and the cathode 112. In one embodiment, the battery 100 is a lithium ion battery, a potassium ion battery or a sodium ion battery. In one embodiment, the anode 110 includes a carbon material. In one embodiment the anode 110 includes a plurality of carbon-based spheres 10. In one embodiment, the cathode 112 includes a carbon material. In one embodiment, the cathode 112 includes a plurality of carbon-based spheres. The anode 110 and the cathode 112 may include other material(s) that are readily known and used in anodes and cathodes, e.g., hard carbon, graphite, other carbon-based material, additives, metallic-based materials, support structures, and the like.

The electrolyte 116 may be organic, ionic liquid, aqueous, or a combination. Standard battery and supercapacitor electrolytes are contemplated. Separator 114 may be in accordance with standard battery separators.

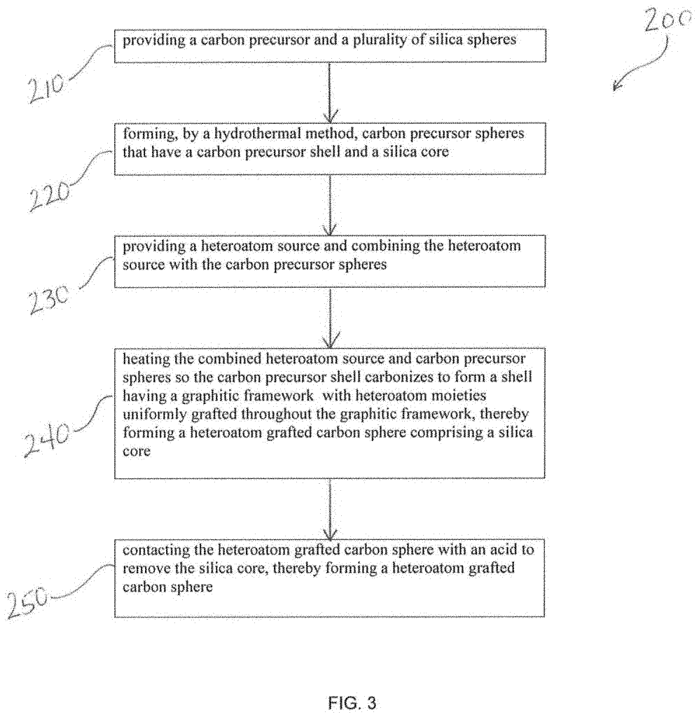

As shown in FIG. 3, a further embodiment is directed to a process 200 for producing (i.e., synthesizing or making) a carbon-based sphere 10, and more particularly a heteroatom grafted carbon sphere. The process 200 can be undertaken in any vessel sufficient to carry out the various steps enumerated herein.

The process 200 includes step 210 of providing a carbon precursor and a plurality of silica spheres. The carbon precursor is styrene-based polymers, formaldehyde polymers, cellulosic polymers, epoxy resins, polyacrylonitrile, and combinations thereof. In a specific embodiment, the carbon precursor is a formaldehyde polymer. In a particular embodiment, the carbon precursor is resorcinol formaldehyde.

In step 220, carbon precursor spheres are formed by a hydrothermal method, i.e., hydrothermal synthesis. As is known, hydrothermal methods (or hydrothermal synthesis) include various techniques of crystallizing substances from high-temperature aqueous solutions at high vapor pressures. The carbon precursor spheres include a carbon precursor shell and a silica core.

In step 230, a heteroatom source is provided and combined with the carbon precursor spheres. In one embodiment, the heteroatom source includes heteroatom moieties selected from the group consisting of N, B, S, Se, P, and combinations thereof. In particular, the heteroatom atom source includes S as the heteroatom moieties.

The combined heteroatom source and carbon precursor spheres are heated in step 240, such that the carbon precursor shell carbonizes to form a shell having a graphitic framework. The heteroatom moieties are uniformly grafted throughout the graphitic framework, thus forming a heteroatom grafted carbon sphere having a silica core. In one embodiment of the process 200, the heating step 240 is conducted for between about 1 to 24 hours at a temperature of between about 100-1500° C. In a particular embodiment, the heating step 240 is conducted between about 2 to 10 hours at a temperature of between about 200-1000° C. In a particular embodiment, the heating step 240 is conducted between about 4 to 6 hours at a temperature of between about 300-500° C. In a particular embodiment, the heating step 240 is conducted for at least five (5) hours at 450° C.

In step 250, the heteroatom grafted carbon sphere is contacted with an acid to remove, i.e., dissolve or “etch”, the silica core, thereby forming a heteroatom grafted carbon sphere. The acid used in step 250 is any acid that is sufficient to remove the silica core, e.g., hydrofluoric (HF) acid, hydrochloric (HCl) acid, and the like. In a particular embodiment, the acid is HF acid.

In one embodiment of the process 200, the shell of the heteroatom grafted carbon sphere includes at least 5 wt. % heteroatom based on the total weight of the shell. In a particular embodiment, the shell includes at least 5 wt. % heteroatom based on the total weight of the shell, more particularly at least 10 wt. % heteroatom based on the total weight of the shell, more particularly at least 15 wt. % heteroatom based on the total weight of the shell, more particularly at least 20 wt. % heteroatom based on the total weight of the shell, more particularly at least 25 wt. % heteroatom based on the total weight of the shell, more particularly at least 30 wt. % heteroatom based on the total weight of the shell, more particularly at least 35 wt. % heteroatom based on the total weight of the shell. In a specific embodiment, the shell includes at least 35 wt. % S based on the total weight of the shell.

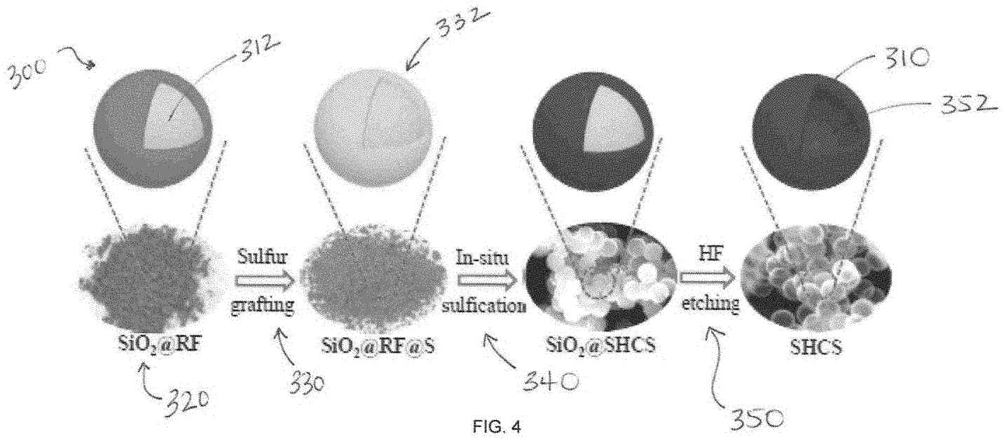

In a particular embodiment, as shown in FIG. 4, a process 300 for producing a sulfur grafted hollow carbon spheres (SHCS) 310 is shown. Resorcinol formaldehyde (RF) resin is used as the carbon source and silica spheres are used as the hard template 312. In step 320, monodisperse RF resin spheres with a silica core 322 (“SiO₂@RF”) are prepared through a hydrothermal method. In step 330, sulfur powder serves as the heteroatom source, which is mixed with the SiO₂@RF to form “SiO₂@RF@S” 332. Step 330 can occur in, e.g., a plenary ball mill. Carbonization and sulfuration are conducted simultaneously in step 340, where the sulfur becomes liquefied and penetrates (i.e., becomes grafted) through the thin RF shells. Increasing the temperature carbonizes the RF. In step 350, HF acid is added to remove the silica template, thereby forming the SHCS 310 having a hollow core 352.

Some of the foregoing embodiments are now discussed in the following examples, which serve only as exemplary disclosures and do not limit the invention as disclosed herein.

### EXAMPLES

### 1. Example 1: Synthesis of Sulfur Grafted Carbon Spheres

I. Materials Synthesis and Characterization

As discussed above, and as shown in FIG. 4, sulfur grafted hollow carbon spheres (SHCS) are prepared through an in-situ sulfuration process. We used resorcinol formaldehyde (RF) resin as the carbon precursor and silica spheres as the hard template. Monodisperse RF resin spheres with silica core (SiO₂@RF) were firstly prepared through hydrothermal method. Sulfur powder and SiO₂@RF were thoroughly mixed by plenary ball milling to form SiO₂@RF@S. The carbonization and sulfuration process were conducted simultaneously. The sulfur firstly became liquefied above 115° C. and penetrated through the thin RF shells. As the temperature increased, the resin started to be carbonized in a sulfur-rich environment. Sulfur forthwith bonds with the condensing carbon atoms and incorporates into the nascent graphitic lattices. The carbonization last for 6 hours at 450° C., during which primary carbon phase formed with low degree of graphitic order. The elimination of sulfur was largely avoided due to the relatively low temperature and the bonding with the carbon phase. The SiO₂@SHCS product after the in-situ sulfuration process was further treated with HF acid to remove the silica template, leaving the hollow carbons.

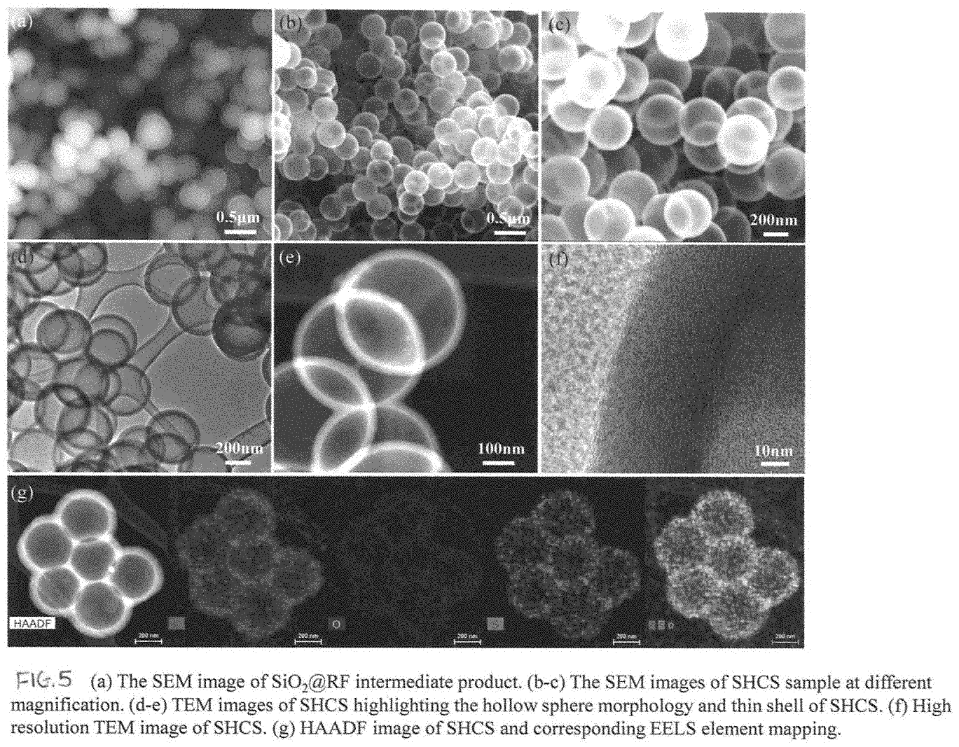

FIG. 5(a) shows the morphology of the SiO₂@RF. The sample displayed monodisperse spheres in shape with diameter of approximately 500 nm. There is contact between the silica core (approximately 300 nm in diameter) and the RF shell under the microscopy. The core-shell contract vanished due to the more dense carbon texture. FIGS. 5 (b),(c) display the morphology of the SHCS sample at different magnifications.

After removing the silica, the carbon framework remained intact as hollow spheres which are uniform in diameter and shell thickness. The well-defined sphere void of the SHCS can be further verified in the TEM images (FIG. 5(d)(e)). The hollow carbon spheres are approximately 400 nm in diameter and approximately 40 nm in shell thickness.

The graphitic texture of the SHCS is highly disordered according to the HRTEM image in FIG. 5(f). Negligible evidence of ordered graphitic nanocrystllites was observed, which is due to the low carbonization temperature. FIG. 2(g) includes a high angle annular dark-filed (HAADF) image of six crowded hollow carbon spheres. The EELS element maps indicate the uniform distribution of element C, S, O. FIG. S2 shows the EDX spectrum of SHCS sample, and the element compositions were listed in the inset Table. Three elements, C, O, S, were detected in the sample. The heteroatom content of S and O are 37.61 wt % and 3.43 wt %, respectively.

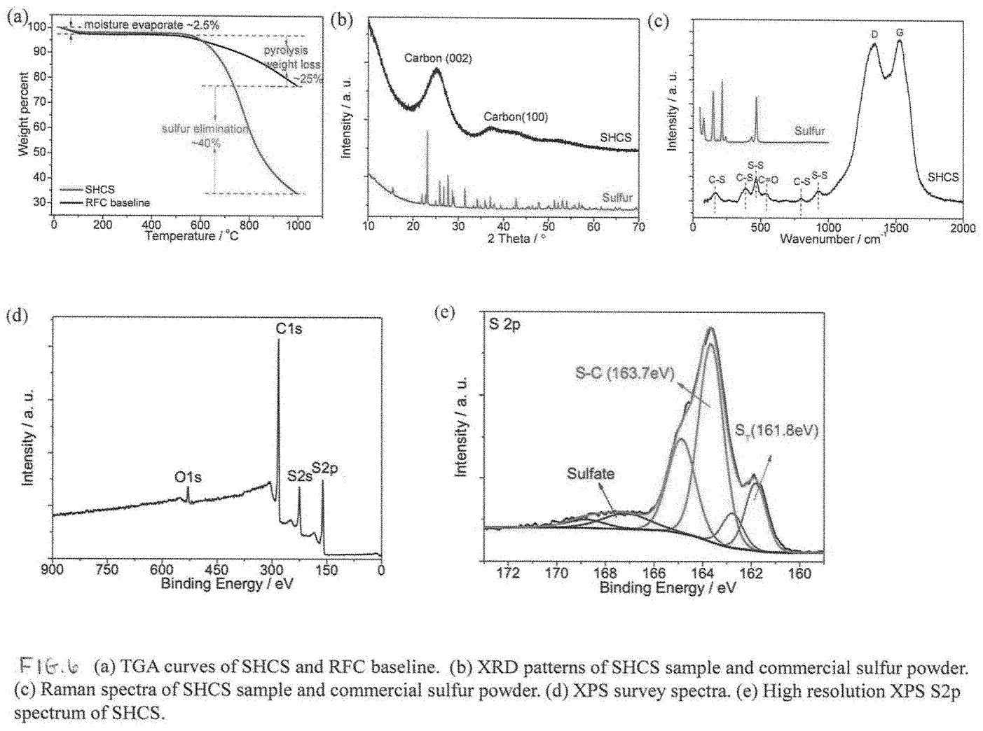

The content of sulfur is further determined by the TGA tests in argon environment (FIG. 6(a)). Below 100° C., both SHCS and the carbonized RF resin baseline (RFC) have ˜2.5% weight loss due to adsorbed moisture. There is no weight loss below 450° C. for RFC, since it was pre-pyrolysis at 450° C. The further heating up to 1000° C. equals to a high temperature post-pyrolysis, in which there is extra 25% weight loss for RFC. SHCS shows negligible weight loss below 500° C., eliminating the existence of element sulfur in the SHCS sample since the boiling point of element sulfur is as low as 445° C. The further heating induced a total weight loss of approximately 65%, which is a combination of sulfur elimination and post-pyrolysis induced weight loss. After deduction, the weight percent of sulfur is approximated to be 40%, in line with the EDX result. The sublimation temperature (>600° C.) of the sulfur species in the SHCS sample is much higher than those of the melt-diffusion prepared carbon-sulfur composites (<300° C.), indicating the strong bonding between sulfur and carbon matrix in SHCS.

FIG. 6(b) shows the XRD pattern of the SHCS sample and the element sulfur baseline. The SHCS sample exhibited an overall amorphous feature without sharp diffraction peaks. The broad hump at 25° and ca. 40° indicted that the RF resin has transformed to graphitic structure after the low temperature pyrolysis. Based on the 2 Theta position of the (002) peak, the interlayer distance between parallel graphene layers is calculated to be 0.36 nm. This space is sufficient for both the Na and K intercalation. The diffraction peaks of element sulfur are totally absent in the SHCS pattern. Therefore, the sulfur lost the orthorhombic crystallinity and transformed into sulfur species in smaller molecular forms.

The atomic bonding configuration in the SHCS sample was investigated by Raman. As shown in FIG. 6(c), there are pronounced D and G bands respectively locating at 1340 and 1530 cm⁻¹, indicating the successful transformation from the resin polymer to carbonaceous texture at the low pyrolysis temperature. The bonding structures between carbon and sulfur atoms were revealed in the lower wavenumber region below 1000 cm⁻¹. There are distinct peaks at 165, 390 and 799 cm⁻¹ which are ascribed to the C—S bonding. This feature illustrates that sulfur has incorporated in the carbon phase in the atomic level. Besides the C—S bond, there are pronounced peaks at 466 and 928 cm⁻¹ ascribing to S—S bonding, which should be resulted from the small sulfur atom condensation domains. Whereas according to the amorphous XRD and the absence of main sulfur Raman peaks, the sulfur atoms have never formed big molecule species (S₈, etc) with a long range ordering.

II. Electrochemistry of SHCS as Anode in Sodium Ion Batteries

The electrochemical property of SHCS anode was firstly tested in sodium half-cells. The reactions occurring can be clearly discriminated by cyclic voltammetry (CV). In a voltage window of 0.01-2.5V vs. Na/Na⁺, there are two separated groups of peaks. The cathodic peaks at ca. 1.9, 1.3 V and the anodic peak at ca. 1.8 V are ascribed to the redox reaction between sodium and sulfur species. Those three peaks overlapped upon cycles indicating the good reversibility of the redox reaction. In the first cycle there is a hump centered in 1.15V, which diminished in following cycles. Based on the specific voltage region, this hump may relate to certain irreversible reaction at the carbon surface. The sodium storage in the carbon bulk resulted in the broad hump region in the low voltage region and the sharp peaks near the standard metal voltage. Due to the low degree of order for the graphitic structure, the dominate Na storage mechanism in the carbon phase is the intercalation in the amorphous carbon bulk and the adsorption in the carbon surface. The small sharp peaks near the metal voltage resulted from a sub-fraction of sodium ions intercalated in the ordered parallel graphene layers.

The galvanostatic voltage profiles were collected at current density of 0.1 Ag⁻¹. The first five cycle profiles were analyzed. In the 1^{st} cycle, the electrode delivered 1210 mAhg⁻¹ capacity for discharge and 885 mAhg⁻¹ for charge, leading to the 1^{st} cycle Coulombic efficiency of 73.1%. As shown in Table 1, the maximum reversible capacity of SHCS anode is outstanding comparing to the very recent carbon anodes.

TABLE 1
A comparison between SHCS and the state-of-the-art heteroatom modified
carbon anodes from the published literature, tested vs. Na/Na⁺.

| | | | | Maximum specific | |
|---|---|---|---|---|---|
| | Hetero-element | Voltage | | capacity (1^{st} charge | |
| Material | content | window | | capacity) | Rate performance |
| SHCS | Sulfur | 0.01-2.5 | V | 884 mAhg⁻¹@100 mAg⁻¹ | 390 mAhg⁻¹@2 Ag⁻¹ |
| | (37.61 wt %) | | | | 317 mAhg⁻¹@5 Ag⁻¹ |
| | | | | | 230 mAhg⁻¹@10 Ag⁻¹ |
| S-doped N- | Nitrogen | 0.01-3 | V | 419 mAhg⁻¹@50 mAg⁻¹ | 190 mAhg⁻¹@2 Ag⁻¹ |
| rich carbon | (20.01 wt %) | | | | 150 mAhg⁻¹@5 Ag⁻¹ |
| nanosheets | Sulfur | | | | 110 mAhg⁻¹@10 Ag⁻¹ |
| | (9.19 wt %) | | | | |
| P doped carbon | Phosphorus | 0.01-3 | V | 336 mAhg⁻¹@100 mAg⁻¹ | 169 mAhg⁻¹@2.5 Ag⁻¹ |
| nanosheets | (1.39 at %) | | | | 143 mAhg⁻¹@5 Ag⁻¹ |
| | Oxygen | | | | 117 mAhg⁻¹@10 Ag⁻¹ |
| | (7.69 at %) | | | | |
| N-doped carbon | Nitrogen | 0-3 | V | 346 mAhg⁻¹@100 mAg⁻¹ | 147 mAhg⁻¹@4.5 Ag⁻¹ |
| nanofibers | (6 at %) | | | | 138 mAhg⁻¹@6.25 Ag⁻¹ |
| | | | | | 128 mAhg⁻¹@7 Ag⁻¹ |
| Red P confined | Phosphorus | 0.001-2 | V | 710 mAhg⁻¹@150 mAg⁻¹ | 365 mAhg⁻¹@6 mAg⁻¹ |
| N-doped | (22.6 wt %) | | | | 291 mAhg⁻¹@9 mAg⁻¹ |
| microporous | Nitrogen | | | | |
| carbon | (15.5 wt %) | | | | |
| Phosphorus- | Phosphorus | 0.01-2.5 | V | 556 mAhg⁻¹@125 mAg⁻¹ | 384 mAhg⁻¹@1.2 Ag⁻¹ |
| carbon composite | (48 wt %) | | | | 300 mAhg⁻¹@3.7 Ag⁻¹ |
| N-doped carbon | Nitrogen | 0.01-2.5 | V | 405 mAhg⁻¹@50 mAg⁻¹ | 129 mAhg⁻¹@2 Ag⁻¹ |
| microspheres | (8.6 at %) | | | | 106 mAhg⁻¹@5 Ag⁻¹ |
| | Oxygen | | | | 90 mAhg⁻¹@10 Ag⁻¹ |
| | (9.9 at %) | | | | |
| S doped | Sulfur | 0.01-3 | V | 561 mAhg⁻¹@20 mAg⁻¹ | 211 mAhg⁻¹@2 Ag⁻¹ |
| disordered | (26.91 wt %) | | | | 158 mAhg⁻¹@4 Ag⁻¹ |
| carbon | | | | | |
| PEDOT | Sulfur | 0.01-2 | V | 482 mAhg⁻¹@100 mAg⁻¹ | 192 mAhg⁻¹@2 Ag⁻¹ |
| derived carbon | (15.17 wt %) | | | | 120 mAhg⁻¹@5 Ag⁻¹ |
| N-doped carbon | Nitrogen | 0.01-3 | V | 437 mAhg⁻¹@100 mAg⁻¹ | 136 mAhg⁻¹@3.2 Ag⁻¹ |
| spheres | (13.39 wt %) | | | | 96 mAhg⁻¹@6.4 Ag⁻¹ |
| | Oxygen | | | | |
| | (11.32 wt %) | | | | |
| F-doped carbon | Fluorine | 0.001-2.8 | V | 232 mAhg⁻¹@50 mAg⁻1 | 102 mAhg⁻¹@3.2 Ag⁻¹ |
| particles | (1.1 at %) | | | | 68 mAhg⁻¹@6.4 Ag⁻¹ |

Similar to the CV curves, the profiles became stable and overlapped after the initial accommodation cycles. From the 4^{th} cycle, the specific capacity stabilized at 680 mAhg⁻¹. According to the voltage profiles, the Na—S reaction provided considerate capacity in the voltage window of 1-2V, making the average voltage of ˜1V for the anode. FIG. 4c shows the rate capability of the SHCS anode under current densities of 0.1-10 Ag⁻¹. Reversible capacities were respectively 390, 320, 230 mAhg⁻¹ at 2, 5 and 10 Ag⁻¹. Benefited from the pronounced capacity contributed by the Na—S redox reaction, the superiority of SHCS anode in rate performance is obvious comparing to the state-of-the-art literature reported carbons.

To understand the kinetics-controlling factors as well as the sodium storage mechanism in SHCS anode, the multi-rate CV test was conducted in the scan rate of 0.1-10 mVs⁻¹. With increasing scan rate (v), the peaks in CV exhibited increasing currents (i) and overpotentials (ΔV). In an electrochemical system, the current changes with the sweep rate are expressed as i=av^{b}, where a, b are adjustable constants. A b-value of 0.5 reflects a diffusion-limited kinetics process in the system, whereas a b-value of 1 is a standard expression for an interface-controlled process. The b value of each redox peak can be extracted from the log i versus log v profiles (FIG. 4e). The Cath-2 peak represents the sodium intercalation in the graphene layers of the small ordered graphitic domains in the carbon phase, which is a totally diffusion-limited bulk reaction. The b-value of Cath-2 peaks is calculated to be 0.67, a bit of larger than the theoretical value of 0.5. While not wanting to be bound be a specific theory, the slightly higher b-value for this bulk intercalation reaction is not necessarily associated to capacitive reaction contribution, but is likely due to the excellent kinetics of the intercalation reaction benefited from the only 40 nm in length bulk ion diffusion distance. Cath-1 and Ano-1 peaks are related to the Na—S redox reaction, and the b-values are calculated to be 0.83 and 0.71, respectively. These values are far below the theoretical value of 1 for absolute interfacial reaction, and also lower than the reported values (above 0.9) of normal pseudo-capacitive dominated carbon anodes. This phenomenon indicated that the Na—S reaction in SHCS is a bulk reaction in majority whose kinetics is diffusion-limited. This feature is totally different from the traditional heteroatom modified carbon anodes, for which only the surficial heteroatom functional groups are active in providing capacities. In the case of SHCS, the heavily loaded sulfur in the carbon bulk has involved in the reaction, which is the critical reason for the much higher capacity of SHCS than any other heteroatom modified carbons. To quantitatively differentiate the contributions from bulk and surficial reaction, currents can be separated (i) at a certain voltage into a diffusion-limited part (k₂v^{1/2}) and an interface-controlled part (k₁v) by equation i=k₁v+k₂v^{1/2}. The connection of the interface-controlled current values at all the voltages formed a new CV curve within the total current based CV curve. An exceptional low capacitive contribution of 56% was obtained at a high scanning rate of 1 mVs⁻¹. This data again proves that the Na—S redox reaction occurs deep in the bulk electrode material.

Cycling performance of SHCS anode in sodium cell was analyzed. For a fresh electrode cycled at 0.3 Ag⁻¹, the main capacity loss occurred in the first five cycles. From the 6^{th} to 250^{th} cycles, the capacity maintenance is 83.2%, i.e. 0.067% capacity loss per cycle. Afterwards, we tested the same cell at high current density of 5 Ag⁻¹ for another 1000 cycles. Since the electrode was already accommodated, there is only 5% capacity loss upon 1000 cycles. For Coulombic efficiency, it mainly stabilized in the 100±0.5% range for the 1250 cycles except for the first several accommodation cycles.

III. Electrochemistry of SHCS as Anode is Potassium Ion Batteries

The SHCS anode was also tested in the potassium half-cell. Analysis indicates that the redox peak of sulfur located at ca. 1.0V and 1.58V vs. K/K⁺ in cathodic and anodic process, respectively. Comparing to the sodium cell, the redox reaction potential is lower in potassium cell, which is a favorable characteristic for anodes. The CV test was also conducted at various scan rates to analyze the reaction kinetics. As shown in FIG. S3, the distortion of CV curve is much more severe in the potassium cell than that in the sodium cell. The intercalation and redox peaks merged together at higher scan rates as a result of increasing overpotential. To obtain useful current values for the quantitative analysis, the scan rate was limited to 1 mVs⁻¹. The b values for the cathodic intercalation and anodic redox reactions are calculated to be 0.59 and 0.52, respectively. Both are approaching the ideal value for diffusion-limited reaction.

The galvanostatic profiles were collected at current density of 25 mAg⁻¹. The first discharge capacity obtained was 1112 mAhg⁻¹, similar to that of sodium cell. The reversible charge capacity is 572 mAhg⁻¹, resulting into 1^{st} cycle Couloumbic efficiency of 51.4%. The K—S redox reaction contributes capacities at ca. 1.1V in discharge and 1.6V in charge, which agree with the redox peaks in CV. Capacity of 581 mAhg⁻¹ was obtained in the second discharge process. This value doubles the value of graphite anode (270 mAhg⁻¹) in potassium cell.

The SHCS electrode was cycled at 0.2 Ag⁻¹ for cyclability test. The electrode maintained 70% of the capacity from the 5^{th} to 250^{th} cycle. The Coulombic efficiency (right vertical axis) increased to 98% from the 3rd cycle and stabilized at 100±0.8% upon the cycling. The capacity retention of SHCS in potassium cell is lower than the value obtained in the sodium cell. It is well expected considering the 35% larger size of potassium ion versus that of sodium ion. Both the intercalation reaction and the redox reaction occur in the material bulk, therefore the larger potassium should lead to higher damage in the material upon cycling. The same pre-cycled electrode exhibited 93% capacity retention after another 1000 cycles at a higher rate of 3 Ag⁻¹.

The SHCS electrode exhibits a specific capacity of 202, 160 and 110 mAhg⁻¹ at 1.5, 3 and 5 Ag⁻¹, respectively. Similar to sodium cell, it is believed that the good rate performance is mainly benefited from the special hollow sphere morphology of SHCS. Although the system underwent bulk reaction, the solid-state diffusion distance of ions has been greatly reduced to the scale of sphere shell thickness, i.e., 40 nm. The materials exhibited better capacity retention upon rate increase in the sodium cell.

Upon analysis, the SHCS anode overwhelms the other reported carbon anodes in the rate range of 0.025-3 Ag⁻¹. The advantage of SHCS is more apparent in the low rate region benefited from the extra high sulfur induced redox capacity. The detailed description of the carbon anodes and the relevant electrochemistry are summarized in Table 2.

TABLE 2
A comparison between SHCS and the state of the art carbon
anodes from the published literature, tested vs. K/K⁺

| | Hetero-element | Voltage | | 1^{st} reversible | |
|---|---|---|---|---|---|
| Material | content | window | | discharge capacity | Rate performance |
| SHCS | Sulfur | 0.01-3.0 | V | 581 mAhg⁻¹@25 mAg⁻¹ | 231 mAhg⁻¹@1.5 Ag⁻¹ |
| | (37.61 wt %) | | | | 176 mAhg⁻¹@3 Ag⁻¹ |
| | | | | | 123 mAhg⁻¹@5 Ag⁻¹ |
| Nitrogen/oxygen | Nitrogen | 0.001-3.0 | V | 365 mAhg⁻¹@25 mAg⁻¹ | 160 mAhg⁻¹@1 Ag⁻¹ |
| co-doped hard | (7.06 at %) | | | | 140 mAhg⁻¹@2 Ag⁻¹ |
| carbon | Oxygen | | | | 120 mAhg⁻¹@3 Ag⁻¹ |
| | (7.90 at %) | | | | |
| Nitrogen-doped | Nitrogen | 0.01-3.0 | V | 297 mAhg⁻¹@50 mAg⁻¹ | 140 mAhg⁻¹@1 Ag⁻¹ |
| carbon nanotubes | (2.40 at %) | | | | 100 mAhg⁻¹@2 Ag⁻¹ |
| | Oxygen | | | | |
| | (7.90 at %) | | | | |
| Nitrogen doped | Nitrogen | 0.01-2.5 | V | 324 mAhg⁻¹@20 mAg⁻¹ | 100 mAhg⁻¹@0.6 Ag⁻¹ |
| cup-stacked | (0.54 at %) | | | | 80 mAhg⁻¹@1 Ag⁻¹ |
| carbon tubes | Oxygen | | | | |
| | (3.04 at %) | | | | |
| Nitrogen doped | Nitrogen | 0.01-3.0 | V | 368 mAhg⁻¹@25 mAg⁻¹ | 172 mAhg⁻¹@1 Ag⁻¹ |
| carbon nanofibers | (13.8 at %) | | | | 153 mAhg⁻¹@2 Ag⁻¹ |
| | Oxygen | | | | |
| | (5.6 at %) | | | | |
| Sulfur/oxygen | Sulfur | 0.01-2.5 | V | 270 mAhg⁻¹@50 mAg⁻¹ | 176 mAhg⁻¹@0.5 Ag⁻¹ |
| co-doped hard | (0.94 at %) | | | | 158 mAhg⁻¹@1 Ag⁻¹ |
| carbon | Oxygen | | | | |
| | (3.92 at %) | | | | |
| Nitrogen doped | Nitrogen | 0.01-3.0 | V | 487 mAhg⁻¹@20 mAg⁻¹ | 225 mAhg⁻¹@1 Ag⁻¹ |
| carbon monolith | (18.9 at %) | | | | 199 mAhg⁻¹@2 Ag⁻¹ |
| Chitin-derived | Nitrogen | 0.01-2.0 | V | 310 mAhg⁻¹@56 mAg⁻¹ | 109 mAhg⁻¹@0.7 Ag⁻¹ |
| nitrogen doped | (7.57 at %) | | | | 85 mAhg⁻¹@1.4 Ag⁻¹ |
| carbon nanofibers | Oxygen | | | | |
| | (34.19 at %) | | | | |
| Hollow carbon | None | 0-2.0 | V | 340 mAhg⁻¹@28 mAg⁻¹ | 190 mAhg⁻¹@0.28 Ag⁻¹ |
| architecture | | | | | 110 mAhg⁻¹@0.56 Ag⁻¹ |
| Short-range ordered | None | 0.01-2.6 | V | 307.4 mAhg⁻¹@50 mAg⁻¹ | 150 mAhg⁻¹@1 Ag⁻¹ |
| mesoporous carbon | | | | | |
| Hard-soft composite | None | 0.01-2.0 | V | 290 mAhg⁻¹@27.9 mAg⁻¹ | 121 mAhg⁻¹@1.4 Ag⁻¹ |
| carbon | | | | | 81 mAhg⁻¹@2.8 Ag⁻¹ |
| Graphite | None | 0.01-1.5 | V | 273 mAhg⁻¹@7 mAg⁻¹ | 170 mAhg⁻¹@0.14 Ag⁻¹ |
| | | | | | 80 mAhg⁻¹@0.28 Ag⁻¹ |
| Graphitic carbon | None | 0-3.0 | V | 240 mAhg⁻¹@56 mAg⁻¹ | 200 mAhg⁻¹@1.4 Ag⁻¹ |
| nanocages | | | | | 160 mAhg⁻¹@5.1 Ag⁻¹ |
| Hyperporous carbon | None | 0.01-2.5 | V | 300 mAhg⁻¹@100 mAg⁻¹ | 200 mAhg⁻¹@0.8 Ag⁻¹ |
| sponge | | | | | 180 mAhg⁻¹@1.6 Ag⁻¹ |

It was observed that for the current carbon anodes, the capacity increase by heteroatom modification is not significant comparing to the baseline of 275 mAhg⁻¹ for graphite. On the contrary, by utilizing the K—S redox reaction, SHCS anode provide 2 X capacity of the graphite anode.

IV. Discussion of Results

The results presented above show that the SHCS anodes have record high specific capacities in both sodium and potassium half cells. To deeply investigate the reaction mechanism in SHCS for charge storage, the inventors conducted ex-situ electrode characterization. As discussed above, the pristine SHCS sample displays pronounced S—S and C—S bonding peaks in the Raman spectrum. After the 1^{st} fully sodiation, the intensities of both S—S and C—S peaks diminished significantly. By collecting the diffraction data of the sodiated sample, the inventors observed crystalline peaks appearing which can be ascribed to Na₂S. The formation of Na₂S can well explain the diminishing of S—S Raman signal since the sodiation process will break the sulfur bond and reduce the sulfur. After the first charging back to 2.5V, the intensity of S—S Raman signal largely recovered. Correspondingly, the Na₂S peaks disappeared in the diffraction spectrum, which again went back to the similar amorphous shape as the pristine one. Besides the change of sulfur species, the reversible sodiation also made changes in the carbon structure. There was an obverse red-shift for the D and G bands after sodiation and a reversible blue-shift in the following desodiation. This phenomenon is due to the tensile stress induced by the sodium intercalation, which also reflects the large volume change of the material upon reversible sodiation. The evolution of the Raman spectra repeated again in the 2^{nd} discharge-charge process, proving the good reversibility of the redox reaction and intercalation reaction of SHCS anode in the sodium cell.

Based on the characterization abovementioned, the reaction mechanism of SHCS is summarized herein. After sodiation, there should be an apparent volume expansion for the carbon shell. The large void space can well buffer this volume change. The sulfur distributed uniformly in the pristine SHCS in the forms of C—S and S—S species. In discharging, sodium reacted with sulfur in the material bulk and formed Na₂S nanocrystalline domains. This mechanism involves a bulk phase transformation, which is significantly different from the non-phase-transition processes occurred in traditional heteroatom containing carbon anodes, for instance the surficial faradic charge transfer at the electrical negative sites and physical ion adsorption at the graphitic defects.

In the counterpart potassium storage mechanism investigation the reversible consuming of S—S and C—S bonding in the ex situ Raman spectra upon potassiation and depotassiation processes was also observed. Apparently, the sulfur species participate in the redox reaction with potassium. For capacity discrepancy between sodium and potassium cells, one possible rationale is the lower alkali to sulfur stoichiometry in the final productions of K—S redox reaction (e.g. K₂S₃, K₂S₂ vs. Na₂S). Galvanostatic intermittent titration technique (GITT) data of SHCS anodes were collected with 0.5 h current pulse of 25 mAg⁻¹ followed by 3 h relaxation. For both discharge and charge processes, the over-potential values in the sodium cell are lower than those of the potassium cell, indicating the better kinetics of the reactions in the sodium cell. Based on the voltage-time relationship, we calculated the chemical diffusion coefficient of Na⁺/K⁺ ions. According to the evolution of diffusion coefficient as a function of voltage, there are apparent kinetics deteriorations at the redox reaction regions in both sodium and potassium cells. This phenomenon indicates the occurrence of the phase transition. Moreover, comparing the coefficient values in discharge and charge, the discharge process is more facile than the charge process, which agrees with the CV tests abovementioned. Overall, the chemical diffusion coefficient of Na⁺ is much higher than those of K⁺ ions. In the discharge process, the diffusion coefficient values of Na⁺ are 2-10 times of K⁺ ion ones. In the charge process, the Na⁺ values are also 2-5 times higher. This result clearly revealed the much more sluggish kinetics of the K⁺ diffusion in the bulk redox reaction and intercalation reaction, which could be a reason for the capacity discrepancy in the two systems.

In summary, in this work, the inventors, for the first time activated the intrinsically sluggish Na—S and K—S redox reactions with the assistance of hollow sphere shaped carbon. These phase-transition reactions with end members of sulfur and metal sulfides contribute significant charge storage capability, which enable the carbon anodes to exhibit record high overall specific capacities in both Na and K cells. Ex-situ characterization and quantitative kinetics analysis revealed that the hetero sulfur atoms in our carbon anode underwent diffusion-controlled bulk reactions, which is substantially different from the pseudocapacitive charge transfer or ion adsorption behavior of traditional heteroatom containing carbon anodes. This revolution in charge storage mechanism leads to the outstanding electrochemical performance of the SHCS anode in this work, and also, opens a new pathway to develop high capacity heteroatom containing carbon anodes for beyond-Li batteries.

As will be apparent to those skilled in the art, various modifications, adaptations and variations of the foregoing specific disclosure can be made without departing from the scope of the invention claimed herein. The various features and elements of the invention described herein may be combined in a manner different than the specific examples described or claimed herein without departing from the scope of the invention. In other words, any element or feature may be combined with any other element or feature in different embodiments, unless there is an obvious or inherent incompatibility between the two, or it is specifically excluded.

References in the specification to “one embodiment,” “an embodiment,” etc., indicate that the embodiment described may include a particular aspect, feature, structure, or characteristic, but not every embodiment necessarily includes that aspect, feature, structure, or characteristic. Moreover, such phrases may, but do not necessarily, refer to the same embodiment referred to in other portions of the specification. Further, when a particular aspect, feature, structure, or characteristic is described in connection with an embodiment, it is within the knowledge of one skilled in the art to affect or connect such aspect, feature, structure, or characteristic with other embodiments, whether or not explicitly described.

The singular forms “a,” “an,” and “the” include plural reference unless the context clearly dictates otherwise. Thus, for example, a reference to “a plant” includes a plurality of such plants. It is further noted that the claims may be drafted to exclude any optional element. As such, this statement is intended to serve as antecedent basis for the use of exclusive terminology, such as “solely,” “only,” and the like, in connection with the recitation of claim elements or use of a “negative” limitation. The terms “preferably,” “preferred,” “prefer,” “optionally,” “may,” and similar terms are used to indicate that an item, condition or step being referred to is an optional (not required) feature of the invention.

The term “and/or” means any one of the items, any combination of the items, or all of the items with which this term is associated. The phrase “one or more” is readily understood by one of skill in the art, particularly when read in context of its usage.

Each numerical or measured value in this specification is modified by the term “about”. The term “about” can refer to a variation of ±5%, ±10%, ±20%, or ±25% of the value specified. For example, “about 50” percent can in some embodiments carry a variation from 45 to 55 percent. For integer ranges, the term “about” can include one or two integers greater than and/or less than a recited integer at each end of the range. Unless indicated otherwise herein, the term “about” is intended to include values and ranges proximate to the recited range that are equivalent in terms of the functionality of the composition, or the embodiment.

As will be understood by the skilled artisan, all numbers, including those expressing quantities of reagents or ingredients, properties such as molecular weight, reaction conditions, and so forth, are approximations and are understood as being optionally modified in all instances by the term “about.” These values can vary depending upon the desired properties sought to be obtained by those skilled in the art utilizing the teachings of the descriptions herein. It is also understood that such values inherently contain variability necessarily resulting from the standard deviations found in their respective testing measurements.

As will be understood by one skilled in the art, for any and all purposes, particularly in terms of providing a written description, all ranges recited herein also encompass any and all possible sub-ranges and combinations of sub-ranges thereof, as well as the individual values making up the range, particularly integer values. A recited range (e.g., weight percents or carbon groups) includes each specific value, integer, decimal, or identity within the range. Any listed range can be easily recognized as sufficiently describing and enabling the same range being broken down into at least equal halves, thirds, quarters, fifths, or tenths. As a non-limiting example, each range discussed herein can be readily broken down into a lower third, middle third and upper third, etc.

As will also be understood by one skilled in the art, all language such as “up to”, “at least”, “greater than”, “less than”, “more than”, “or more”, and the like, include the number recited and such terms refer to ranges that can be subsequently broken down into sub-ranges as discussed above. In the same manner, all ratios recited herein also include all sub-ratios falling within the broader ratio. Accordingly, specific values recited for radicals, substituents, and ranges, are for illustration only; they do not exclude other defined values or other values within defined ranges for radicals and substituents.

One skilled in the art will also readily recognize that where members are grouped together in a common manner, such as in a Markush group, the invention encompasses not only the entire group listed as a whole, but each member of the group individually and all possible subgroups of the main group. Additionally, for all purposes, the invention encompasses not only the main group, but also the main group absent one or more of the group members. The invention therefore envisages the explicit exclusion of any one or more of members of a recited group. Accordingly, provisos may apply to any of the disclosed categories or embodiments whereby any one or more of the recited elements, species, or embodiments, may be excluded from such categories or embodiments, for example, as used in an explicit negative limitation.

What is claimed is:

1. A battery electrode comprising:
a plurality of carbon-based spheres, wherein at least one of said carbon-based spheres comprises a shell and a hollow interior, the shell formed from a carbon precursor grafted with heteroatom moieties.

2. The battery electrode according to claim 1, wherein the carbon precursor is selected from the group consisting of styrene-based polymers, formaldehyde polymers, cellulosic polymers, epoxy resins, polyacrylonitrile, and combinations thereof.

3. The battery electrode according to claim 2, wherein the carbon precursor is a formaldehyde polymer.

4. The battery electrode according to claim 3, wherein the formaldehyde polymer is resorcinol formaldehyde.

5. The battery electrode according to claim 1, wherein the heteroatom moieties are selected from the group consisting of N, B, S, Se, P, and combinations thereof.

6. The battery electrode according to claim 5, wherein the heteroatom moieties are S.

7. The battery electrode according to claim 6, wherein the shell comprises at least 5 wt. % S based on the total weight of the shell.

8. The battery electrode according to claim 1, wherein the heteroatom moieties are uniformly distributed throughout a framework of the shell.

9. A battery comprising:
an anode;
a cathode;
a separator disposed between the anode and the cathode; and
an electrolyte in physical contact with both the anode and the cathode,
wherein one of the anode and the cathode is the battery electrode according to claim 1.

10. The battery according to claim 9, wherein the battery is a lithium ion battery, a potassium ion battery or a sodium ion battery.

11. A process for producing a heteroatom grafted carbon sphere, the process comprising:
(a) providing a carbon precursor and a plurality of silica spheres;
(b) forming, by a hydrothermal method, carbon precursor spheres comprising a carbon precursor shell and a silica core;
(c) providing a heteroatom source and combining the heteroatom source with the carbon precursor spheres;
(d) heating the combined heteroatom source and carbon precursor spheres such that the carbon precursor shell carbonizes to form a shell having a graphitic framework with heteroatom moieties uniformly grafted throughout the graphitic framework, thereby forming a heteroatom grafted carbon sphere comprising a silica core; and
(e) contacting the heteroatom grafted carbon sphere with an acid to remove the silica core, thereby forming a heteroatom grafted carbon sphere.

12. The process according to claim 11, wherein the carbon precursor is selected from the group consisting of styrene-based polymers, formaldehyde polymers, cellulosic polymers, epoxy resins, polyacrylonitrile, and combinations thereof.

13. The process according to claim 12, wherein the carbon precursor is a formaldehyde polymer.

14. The process according to claim 13, wherein the formaldehyde polymer is resorcinol formaldehyde.

15. The process according to claim 11, wherein the heteroatom source includes heteroatom moieties selected from the group consisting of N, B, S, Se, P, and combinations thereof.

16. The process according to claim 15, wherein the heteroatom moieties are S.

17. The process according to claim 16, wherein the shell of the heteroatom grafted carbon sphere comprises at least 5 wt. % S based on the total weight of the shell.

18. The process according to claim 11, wherein the heating step is conducted for between about 1 to 24 hours at a temperature of between about 100-1500° C.
